(19) United States
(12) Patent Application Publication
(10) Pub. No.: US 2026/0342450 A1
(43) Pub. Date: Oct. 29, 2026

(54) OPTICAL TRANSMISSION SYSTEM, OPTICAL RECEIVING APPARATUS AND OPTICAL TRANSMISSION METHOD

(71) Applicant: NTT, Inc., Tokyo (JP)

(72) Inventors: Yukinobu NAKAJIMA, Musashino-shi (JP); Yoshiaki KISAKA, Musashino-shi (JP); Yoshiaki SONE, Musashino-shi (JP); Kei KITAMURA, Musashino-shi (JP); Masanori NAKAMURA, Musashino-shi (JP); Hiroki TANIGUCHI, Musashino-shi (JP); Takashi SAIDA, Musashino-shi (JP)

(73) Assignee: NTT, Inc., Tokyo (JP)

(21) Appl. No.: 19/118,442

(22) PCT Filed: Oct. 31, 2022
(86) PCT No.: PCT/JP2022/040607

§ 371 Date: Apr. 4, 2025

(51) Int. Cl. H04B 10/63; H04J 14/06

(52) U.S. Cl. CPC H04B 10/63; H04J 14/06

(57) ABSTRACT

An optical transmitting apparatus includes an optical output, a brancher, and an optical modulator. The optical output outputs light having a single wavelength. The brancher branches the output light into light for signal generation and local oscillation light. The optical modulator modulates light for the signal generation into polarized wave-multiplexed signal light. An optical receiving apparatus includes an optical detector, a signal processor, and a polarized wave controller. The optical detector coherently detects the signal light transmitted through an optical transmission line by the local oscillation light transmitted through an optical transmission line different from the optical transmission line through which the signal light is transmitted. The signal processor generates local oscillation light polarized wave control information for compensating for a fluctuation that has occurred in a polarized wave of local oscillation light during transmission on a basis of a signal obtained by coherent detection. The polarized wave controller performs polarized wave control of local oscillation light used by the optical detector for coherent detection using local oscillation light polarized wave control information.

### TECHNICAL FIELD

The present invention relates to an optical transmission system, an optical receiving apparatus and an optical transmission method.

### BACKGROUND ART

There is an optical transmission system of a self-homodyne method (see, for example, Non Patent Literature 1). The self-homodyne method is a method in which an optical transmitting apparatus transmits signal light and local oscillation light output from the same laser to an optical receiving apparatus via different optical transmission lines (for example, optical fibers), and coherent detection is performed using the signal light and the local oscillation light received by the optical receiving apparatus.

FIG. 6 is a diagram illustrating an example of an optical transmission system of the self-homodyne method.

In an optical transmitting apparatus, light generated by an optical output is branched into two pieces, one piece of light is output to an optical modulator, and the other piece of light is output to an optical transmission line as local oscillation light. The optical modulator generates polarized wave division multiplexed signal light by modulating light generated by the optical output using an electric signal input from a digital signal processor. The optical modulator outputs the generated signal light to an optical transmission line different from that of the local oscillation light. The optical receiving apparatus receives the signal light and the local oscillation light. An optical detector performs homodyne detection of the signal light using the local oscillation light subjected to polarized wave control by a polarized wave controller. The digital signal processor demodulates the signal light subjected to the homodyne detection.

The polarized wave controller performs polarized wave control of a local oscillation signal as follows. That is, a photoelectric convertor receives as input a part of local oscillation light subjected to polarized wave control by a polarized wave control apparatus, and converts the received local oscillation light into an electric signal. An ADC converts the electric signal obtained by the conversion from an analog signal to a digital signal. The digital signal processor generates local oscillation light polarized wave control information on the basis of the digital signal obtained by the conversion. The local oscillation light polarized wave control information is information used for compensating for polarized wave rotation and polarized wave mode dispersion that have occurred in a case where local oscillation light is transmitted through an optical transmission line. The ADC converts the local oscillation light polarized wave control information from a digital signal to an analog signal. An electric signal amplifier amplifies the local oscillation light polarized wave control information. The polarized wave control apparatus performs polarized wave control of the local oscillation signal received from the optical transmitting apparatus using the amplified local oscillation light polarized wave control information and outputs the same to the optical detector.

In the self-homodyne method, since a signal light and local oscillation light have the same center frequency and reference phase, it is possible to reduce influence of laser phase noise and eliminate a frequency offset. Therefore, there are the following advantages as compared with a method of performing coherent detection using local oscillation light included in an optical receiving apparatus. One advantage is that a laser having a wide line width and low frequency accuracy can be used as the optical output of the optical receiving apparatus. Another advantage is that it is possible to simplify signal processing for phase noise compensation and frequency offset compensation performed by the digital signal processor after coherent detection is performed by the optical detector of the optical receiving apparatus.

### CITATION LIST

### Non Patent Literature

Non Patent Literature 1: T Gui, et al., “Real-Time Demonstration of Homodyne Coherent Bidirectional Transmission for Next-Generation Data Center Interconnects,” Journal of Lightwave Technology, Vol. 39, No. 4, pp. 1231-1238, 2021.

### SUMMARY OF INVENTION

### Technical Problem

In order to perform coherent detection, it is necessary to control a polarized wave of local oscillation light transmitted from the transmission side in an optical receiving apparatus as described above. In the self-homodyne method illustrated in Non Patent Literature 1, a photoelectric convertor, an ADC, a digital signal processor, a DAC, an electric signal amplifier, and a polarized wave control apparatus are required for polarized wave control of local oscillation light transmitted from an optical transmitting apparatus. This is a constraint on power consumption reduction and downsizing.

In view of the above circumstances, an object of the present invention is to provide an optical transmission system, an optical receiving apparatus and an optical transmission method capable of reducing power consumption and downsizing an apparatus in optical transmission of a self-homodyne method.

### Solution to Problem

An aspect of the present invention is an optical transmission system including an optical transmitting apparatus and an optical receiving apparatus, in which the optical transmitting apparatus includes: an optical output that outputs light having a single wavelength; a brancher that branches the light output from the optical output into light for signal generation and local oscillation light; and an optical modulator that modulates light for the signal generation into polarized wave-multiplexed signal light, and the optical receiving apparatus includes: an optical detector that coherently detects the signal light transmitted through an optical transmission line by the local oscillation light transmitted through an optical transmission line different from the optical transmission line through which the signal light is transmitted; a signal processor that generates local oscillation light polarized wave control information for compensating for a fluctuation that has occurred in a polarized wave of local oscillation light during transmission on a basis of a signal obtained by coherent detection; and a polarized wave controller that performs polarized wave control of the local oscillation light used by the optical detector for coherent detection on a basis of the local oscillation light polarized wave control information.

An aspect of the present invention is an optical receiving apparatus including: an optical detector that branches light having a single wavelength into light for signal generation and local oscillation light, receives as input, from an optical transmitting apparatus that modulates light for the signal generation to generate polarized wave-multiplexed signal light, the signal light and the local oscillation light transmitted via different optical transmission lines, and coherently detects the signal light by the local oscillation light; a signal processor that generates local oscillation light polarized wave control information for compensating for a fluctuation that has occurred in a polarized wave of local oscillation light during transmission on a basis of a signal obtained by coherent detection; and a polarized wave controller that performs polarized wave control of the local oscillation light used by the optical detector for coherent detection on a basis of the local oscillation light polarized wave control information.

An aspect of the present invention is an optical transmission method in an optical transmission system including an optical transmitting apparatus and an optical receiving apparatus, including: an optical output step of, by the optical transmitting apparatus, outputting light having a single wavelength; a branching step of, by the optical transmitting apparatus, branching the light output in the optical output step into light for signal generation and local oscillation light; an optical modulation step of, by the optical transmitting apparatus, modulating light for the signal generation into polarized wave-multiplexed signal light; an optical detection step of, by the optical receiving apparatus, coherently detecting the signal light transmitted through an optical transmission line by the local oscillation light transmitted through an optical transmission line different from the optical transmission line through which the signal light is transmitted; a signal processing step of, by the optical receiving apparatus, generating local oscillation light polarized wave control information for compensating for a fluctuation that has occurred in a polarized wave of local oscillation light during transmission on a basis of a signal obtained by coherent detection; and a polarized wave control step of, by the optical receiving apparatus, performing polarized wave control of the local oscillation light used for the coherent detection on a basis of the local oscillation light polarized wave control information.

### Advantageous Effects of Invention

According to the present invention, it is possible to reduce power consumption and downsize an apparatus in optical transmission of a self-homodyne method.

### BRIEF DESCRIPTION OF DRAWINGS

FIG. 1 is a diagram illustrating a configuration example of an optical transmission system according to a first embodiment of the present invention.

FIG. 2 is a diagram illustrating a configuration example of the optical transmission system according to the first embodiment.

FIG. 3 is a diagram illustrating a configuration example of an optical transmission system according to a second embodiment.

FIG. 4 is a diagram illustrating a configuration example of the optical transmission system according to the second embodiment.

FIG. 5 is a diagram illustrating a configuration example of an optical transmission system according to a third embodiment.

FIG. 6 is a diagram illustrating a configuration example of a conventional optical transmission system.

### DESCRIPTION OF EMBODIMENTS

Embodiments of the present invention will now be described in detail with reference to the drawings. Note that the same parts will be denoted by the same reference signs in the drawings, and the description thereof will be omitted.

The present embodiment relates to an optical transmission system of an optical transmission system using a self-homodyne method. An optical transmitting apparatus transmits signal light and local oscillation light having the same wavelength output from the same laser to an optical receiving apparatus via different optical fibers. The optical receiving apparatus performs coherent detection of the received signal light using the received local oscillation light. The optical receiving apparatus includes: a digital signal processor that generates, on the basis of an output signal of coherent detection, local oscillation light polarized wave control information for compensating for a fluctuation that has occurred in a polarized wave of local oscillation light during transmission through an optical fiber; and a polarized wave controller that performs polarized wave control of the local oscillation light using local oscillation light polarized wave control information. As a result, the number of functional blocks for controlling a polarized wave of local oscillation light transmitted from the optical transmitting apparatus is reduced, and polarized wave control is efficiently performed.

### First Embodiment

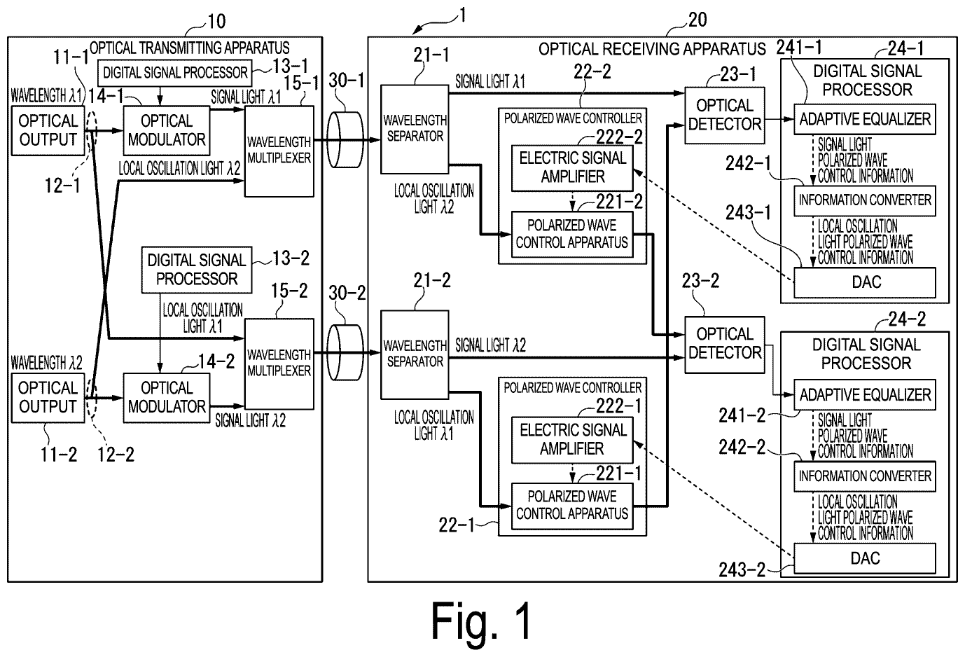

An optical transmission system of a first embodiment uses an optical communication method of a self-homodyne method using wavelength division multiplexing and polarized wave division multiplexing. FIG. 1 is a block diagram illustrating a configuration of an optical transmission system 1 according to the first embodiment. Note that, among connection lines in FIG. 1, thin solid line arrows indicate paths of electric data signals, thick solid line arrows indicate paths of light data signals, and thin broken line arrows indicate paths of electric control signals. This similarly applies to other drawings unless otherwise defined.

The optical transmission system 1 includes an optical transmitting apparatus 10 and an optical receiving apparatus 20. The optical transmitting apparatus 10 and the optical receiving apparatus 20 are connected by a plurality of optical transmission lines 30. M (M is an integer of 2 or more) optical transmission lines 30 are referred to as optical transmission lines 30-1 to 30-M. The internal configurations of the optical transmitting apparatus 10 and the optical receiving apparatus 20 will be described.

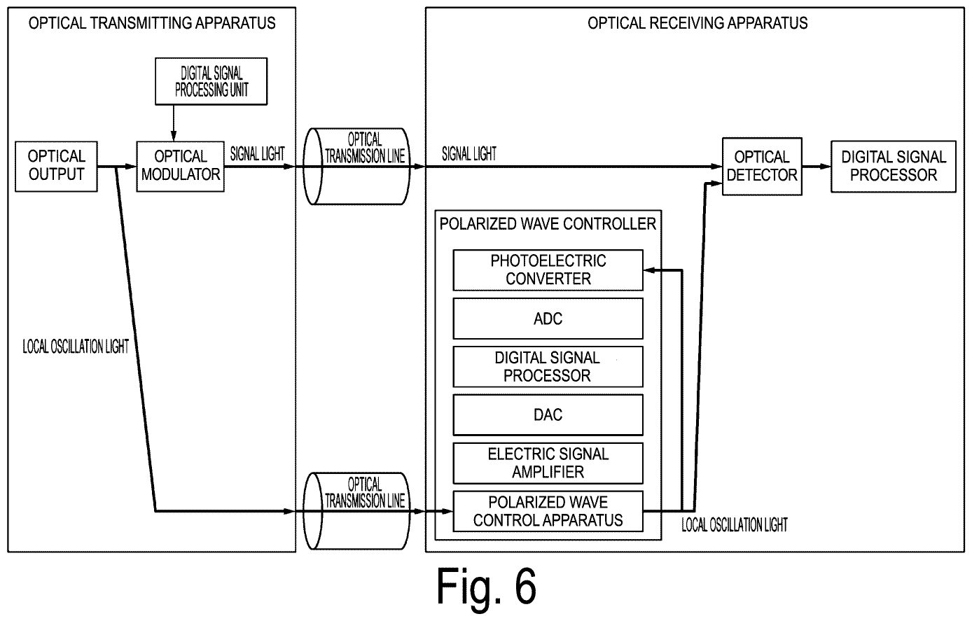

The optical transmitting apparatus 10 includes N (N is an integer of 2 or more, and N≥M is defined) optical outputs 11, N branchers 12, N digital signal processors 13, N optical modulators 14, and M wavelength multiplexers 15. As the optical outputs 11, the branchers 12, and the digital signal processors 13, the optical outputs, branchers, and the digital signal processors included in the optical transmitting apparatus of the conventional technology illustrated in FIG. 6 can be used. The N optical outputs 11 are referred to as optical outputs 11-1 to 11-N, the N branchers 12 are referred to as branchers 12-1 to 12-N, the N digital signal processors 13 are referred to as digital signal processors 13-1 to 13-N, the N optical modulators 14 are referred to as optical modulators 14-1 to 14-N, and the M wavelength multiplexers 15 are referred to as wavelength multiplexers 15-1 to 15-M. FIG. 1 illustrates an example of a case where N=M=2 is defined. Signal light having a wavelength λi (i is an integer of 1 or more and N or less) is also referred to as signal light λi, and local oscillation light having the wavelength λi is also referred to as local oscillation light λi.

Each of the optical outputs 11 can be formed using, for example, a distributed feedback (DFB) laser, an external cavity laser (ECL), a vertical cavity surface emitting laser (VCSEL), or the like. The optical output 11-i generates light having a single wavelength λi. The brancher 12-i branches the light generated by the optical output 11-i and outputs the branched light to the optical modulator 14-i and the wavelength multiplexer 15-j (j is an integer of 1 or more and N or less, and i≠j is defined).

Each of the digital signal processors 13 can be formed using, for example, an application specific integrated circuit (ASIC), a field-programmable gate array (FPGA), or the like. The digital signal processor 13-igenerates an electric signal and outputs the generated electric signal to the optical modulator 14-i.

Each of the optical modulators 14 can be formed using, for example, a Mach-Zehnder type optical modulator or the like. The light having the wavelength λi output from the optical output 11-i and branched by the brancher 12-i is input to the optical modulator 14-i. The optical modulator 14-i modulates the input light having the wavelength λi using the electric signal input from the digital signal processor 13-i, and generates signal light having a power ratio of 1:1 between the x-polarized wave and the y-polarized wave. The optical modulator 14-ioutputs the generated signal light having the wavelength λi to the wavelength multiplexer 15-m (m is an integer of 1 or more and M or less). Here, assume that i=m is defined.

Each of the wavelength multiplexers 15 can be formed using, for example, a planar lightwave circuit (PLC), micro electro mechanical systems (MEMS), or the like. Each of the wavelength multiplexers 15 multiplexes input light having different wavelengths by wavelength division multiplexing. The signal light having the wavelength λi modulated by the optical modulator 14-i and the local oscillation light having the wavelength λj output from the optical output 11-j and branched by the brancher 12-j are input to the wavelength multiplexer 15-m. The wavelength multiplexer 15-m multiplexes the signal light having the wavelength λi and the local oscillation light having the wavelength λj, and outputs the multiplexed light to the optical transmission line 30-m.

The optical receiving apparatus 20 includes M wavelength separators 21, N polarized wave controllers 22, N optical detectors 23, and N digital signal processors 24. The M wavelength separators 21 are referred to as wavelength separators 21-1 to 21-M, the N polarized wave controllers 22 are referred to as polarized wave controllers 22-1 to 22-N, the N optical detectors 23 are referred to as optical detectors 23-1 to 23-N, and the N digital signal processors 24 are referred to as digital signal processors 24-1 to 24-N.

Each of the polarized wave controllers 22 includes a polarized wave control apparatus 221 and an electric signal amplifier 222. The polarized wave control apparatus 221 and the electric signal amplifier 222 included in the polarized wave controller 22-i are referred to as the polarized wave control apparatus 221-i and the electric signal amplifier 222-i, respectively. Each of the digital signal processors 24 includes an adaptive equalizer 241, an information converter 242, and a digital-to-analog converter 243. The adaptive equalizer 241, the information converter 242, and the DAC 243 included in the digital signal processor 24-i are referred to as the adaptive equalizer 241-i, the information converter 242-i, and the DAC 243-i, respectively.

Each of the wavelength separators 21 can be formed using, for example, PLC, MEMS, or the like. The wavelength separator 21-m separates multiplexed light by the wavelength, and outputs the separated light having each wavelength to different paths. The wavelength separator 21-m separates light input from the optical transmission line 30-m by the wavelength. The wavelength separator 21-m outputs the separated signal light having the wavelength λi to the optical detector 23-i, and outputs the separated local oscillation light having the wavelength λj to the polarized wave control apparatus 221-j of the polarized wave controller 22-j.

The polarized wave control apparatus 221 can be formed using, for example, an optical waveguide. The polarized wave control apparatus 221 performs polarized wave control of local oscillation light using local oscillation light polarized wave control information. The polarized wave control of local oscillation light in the polarized wave control apparatus 221 may be, for example, control performed such that the power ratio between the x-polarized wave and the y-polarized wave is 1:1, or may be control performed such that a single polarized wave direction such as the x-polarized wave or the y-polarized wave is set and the power ratio between the x-polarized wave and the y-polarized wave of the local oscillation light is 1:1 in the optical detector 23. The polarized wave control apparatus 221-j performs polarized wave control related to polarized wave rotation and polarized wave mode dispersion on the local oscillation light having the wavelength λj input from the wavelength separator 21-musing local oscillation light polarized wave control information input from the electric signal amplifier 222-j. The local oscillation light polarized wave control information indicates fluctuations of polarized wave rotation, polarized wave mode dispersion, and the like that have occurred in a case where the polarized wave of the local oscillation light having the wavelength λj is transmitted through the optical transmission line 30. The polarized wave control apparatus 221-j outputs the local oscillation light having the wavelength λj subjected to polarized wave control to the optical detector 23-j.

The electric signal amplifier 222 can be formed using, for example, a driver. The electric signal amplifier 222-j receives the local oscillation light polarized wave control information from the digital signal processor 24-i that has processed a result of the coherent detection of the signal light having the wavelength λi multiplexed with the local oscillation light having the wavelength λj. The electric signal amplifier 222-jamplifies the received local oscillation light polarized wave control information and outputs the amplified local oscillation light polarized wave control information to the polarized wave control apparatus 221-j.

Each of the optical detectors 23 can be formed using, for example, a 90 degree hybrid and a balanced photo diode (BPD). Each of the optical detectors 23 performs coherent detection of signal light using local oscillation light and converts the signal light into an electric signal. The optical detector 23-i performs coherent detection on the signal light having the wavelength λi input from the wavelength separator 21-i using the local oscillation light having the wavelength λi input from the polarized wave control apparatus 221-i, and generates an electric signal. The optical detector 23-i outputs the generated electric signal to the adaptive equalizer 241-iof the digital signal processor 24-i.

The adaptive equalizer 241 can be formed using, for example, an ASIC, an FPGA, or the like. The adaptive equalizer 241-i compensates for polarized wave rotation and polarized wave mode dispersion to the electric signal input from the optical detector 23-i using, for example, a blind equalization algorithm (constant modulus algorithm (CMA)). The adaptive equalizer 241-i outputs tap coefficient information generated in a case where polarized wave rotation and polarized wave mode dispersion are compensated for to the electric signal input from the optical detector 23-i to the information converter 242-i as signal light polarized wave control information.

The information converter 242 can be formed using, for example, an ASIC, an FPGA, or the like. The information converter 242-i generates Jones matrix information that is the local oscillation light polarized wave control information by performing Fourier transform on the tap coefficient information that is the signal light polarized wave control information input from the adaptive equalizer 241-i. The Jones matrix information represents polarized wave rotation and polarized wave mode dispersion that have occurred in light during transmission through the optical transmission line 30-m. The information converter 242-i outputs the local oscillation light polarized wave control information to the DAC 243-i.

The DAC 243-i converts the local oscillation light polarized wave control information generated by the information converter 242-i into an analog signal. The DAC 243-i outputs the local oscillation light polarized wave control information converted into the analog signal to the electric signal amplifier 222-j of the polarized wave controller 22-j corresponding to the local oscillation light having the wavelength λj multiplexed with the signal light having the wavelength λi and transmitted.

The optical transmission lines 30-1 to 30-M can be formed using, for example, M separate single mode fibers (SMFs). Alternatively, the optical transmission lines 30-1 to 30-M can be formed using one multi core fiber (MCF) or the like. The light input from the wavelength multiplexer 15-m of the optical transmitting apparatus 10 is transmitted through the optical transmission line 30-m. The light transmitted through the optical transmission line 30-m is output to the wavelength separator 21-m of the optical receiving apparatus 20.

With the above configuration, the optical transmission system 1 illustrated in FIG. 1 operates as follows. The optical output 11-1 of the optical transmitting apparatus 10 generates light having a single wavelength λ1. The brancher 12-1 branches the light having the wavelength λ1 output from the optical output 11-1 into two pieces. The brancher 12-1 outputs one piece of the branched light having the wavelength λ1 to the optical modulator 14-1. The brancher 12-1 outputs the other piece of the branched light having the wavelength λ1 to the wavelength multiplexer 15-2 as local oscillation light.

The optical output 11-2 generates light having a single wavelength 12. The brancher 12-2 branches the light having the wavelength 22 output from the optical output 11-2 into two pieces. The brancher 12-2 outputs one piece of the branched light having the wavelength λ2 to the optical modulator 14-2. The brancher 12-2 outputs the other piece of the branched light having the wavelength λ2 to the wavelength multiplexer 15-1 as local oscillation light.

The optical modulator 14-1 modulates the light having the wavelength λ1 using an electric signal generated by the digital signal processor 13-1 to generate polarized wave division multiplexed signal light, and outputs the generated signal light to the wavelength multiplexer 15-1. The wavelength multiplexer 15-1 multiplexes the signal light having the wavelength λ1 input from the optical modulator 14-1 and the local oscillation light having the wavelength λ2 input from the optical output 11-2, and outputs the multiplexed light to the optical transmission line 30-1. The light input from the wavelength multiplexer 15-1 is transmitted through the optical transmission line 30-1 and then output to the wavelength separator 21-1 of the optical receiving apparatus 20.

The optical modulator 14-2 modulates the light having the wavelength λ2 using an electric signal generated by the digital signal processor 13-2 to generate polarized wave division multiplexed signal light, and outputs the generated signal light to the wavelength multiplexer 15-2. The wavelength multiplexer 15-2 multiplexes the signal light having the wavelength λ2 input from the optical modulator 14-2 and the local oscillation light having the wavelength λ1input from the optical output 11-1, and outputs the multiplexed light to the optical transmission line 30-2. The light input from the wavelength multiplexer 15-2 is transmitted through the optical transmission line 30-2 and then output to the wavelength separator 21-2 of the optical receiving apparatus 20.

The wavelength separator 21-1 separates light input from the optical transmission line 30-1 by the wavelength. The wavelength separator 21-1 outputs the separated signal light having the wavelength λ2 to the optical detector 23-1, and outputs the separated local oscillation light having the wavelength λ2 to the polarized wave control apparatus 221-2. The polarized wave control apparatus 221-2 performs polarized wave control related to polarized wave rotation and polarized wave mode dispersion on the local oscillation light having the wavelength λ2 input from the wavelength Separator 21-1 using local oscillation light polarized wave control information input from the electric signal amplifier 222-2. The polarized wave control apparatus 221-2 outputs the local oscillation light having the wavelength λ2 subjected to polarized wave control to the optical detector 23-2.

The wavelength separator 21-2 separates light input from the optical transmission line 30-2 by the wavelength. The wavelength separator 21-2 outputs the separated signal light having the wavelength λ2 to the optical detector 23-2, and outputs the separated local oscillation light having the wavelength λ1 to the polarized wave control apparatus 221-1. The polarized wave control apparatus 221-1 performs polarized wave control related to polarized wave rotation and polarized wave mode dispersion on the local oscillation light having the wavelength λ1 input from the wavelength separator 21-2 using local oscillation light polarized wave control information input from the electric signal amplifier 222-1. The polarized wave control apparatus 221-1 outputs the local oscillation light having the wavelength λ1 subjected to polarized wave control to the optical detector 23-1.

Note that the polarized wave control apparatuss 221-1 and 221-2 control the polarized wave without using the local oscillation light polarized wave control information obtained by converting the signal light polarized wave control information in a case where optical communication has been just started, and control the polarized wave using the local oscillation light polarized wave control information obtained by converting the signal light polarized wave control information in a case where the signal light polarized wave control information has been generated.

The optical detector 23-1 performs coherent detection on the signal light having the wavelength λ1 input from the wavelength separator 21-1 using the local oscillation light having the wavelength λ1 input from the polarized wave control apparatus 221-1, and generates an electric signal. The optical detector 23-1 outputs the generated electric signal to the adaptive equalizer 241-1.

The adaptive equalizer 241-1 compensates for polarized wave rotation and polarized wave mode dispersion to the electric signal input from the optical detector 23-1. The adaptive equalizer 241-1 outputs tap coefficient information generated in a case where polarized wave rotation and polarized wave mode dispersion are compensated for to the information converter 242-1 as signal light polarized wave control information. The information converter 242-1 generates local oscillation light polarized wave compensation information on the basis of the signal light polarized wave control information input from the adaptive equalizer 241-1. The information converter 242-1 outputs the generated local oscillation light polarized wave compensation information to the DAC 243-1. The DAC 243-1 converts the local oscillation light polarized wave control information into an analog signal, and outputs the local oscillation light polarized wave control information that is the analog signal to the electric signal amplifier 222-2. The electric signal amplifier 222-2 amplifies the local oscillation light polarized wave control information input from the DAC 243-1 and outputs the amplified local oscillation light polarized wave control information to the polarized wave control apparatus 221-2.

The optical detector 23-2 performs coherent detection on the signal light having the wavelength λ2 input from the wavelength separator 21-2 using the local oscillation light having the wavelength λ2 input from the polarized wave control apparatus 221-2, and generates an electric signal. The optical detector 23-2 outputs the generated electric signal to the adaptive equalizer 241-2.

The adaptive equalizer 241-2 compensates for polarized wave rotation and polarized wave mode dispersion to the electric signal input from the optical detector 23-2. The adaptive equalizer 241-2 outputs tap coefficient information generated in a case where polarized wave rotation and polarized wave mode dispersion are compensated for to the information converter 242-2 as signal light polarized wave control information. The information converter 242-2 generates local oscillation light polarized wave compensation information on the basis of the signal light polarized wave control information input from the adaptive equalizer 241-2. The information converter 242-2 outputs the generated local oscillation light polarized wave compensation information to the DAC 243-2. The DAC 243-2 converts the local oscillation light polarized wave control information into an analog signal, and outputs the local oscillation light polarized wave control information that is the analog signal to the electric signal amplifier 222-1. The electric signal amplifier 222-1 amplifies the local oscillation light polarized wave control information input from the DAC 243-2 and outputs the amplified local oscillation light polarized wave control information to the polarized wave control apparatus 221-1.

In a case where the optical transmitting apparatus 10 generates light having three or more wavelengths, each of the wavelength multiplexers 15 performs wavelength division multiplexing such that at least one piece of signal light and at least one piece of local oscillation light having different wavelengths are included, and outputs the light to the optical transmission line 30. The optical receiving apparatus 20 includes the polarized wave controllers 22, the optical detectors 23, and the digital signal processors 24 for the number of wavelengths N. The local oscillation light output from the optical transmission line 30 is subjected to polarized wave control by the polarized wave controller 22 according to the wavelength of the local oscillation light in the optical receiving apparatus 20. The signal light and the local oscillation light are coherently detected by the optical detector 23 for each wavelength, and an electric signal obtained by the coherent detection is output to the digital signal processor 24 corresponding to the wavelength. The digital signal processor 24 generates the local oscillation light polarized wave control information on the basis of the input electric signal. The polarized wave controller 22 controls the polarized wave of the local oscillation light using at least one piece of the local oscillation light polarized wave control information generated by signal light that has passed through the optical transmission line 30 same as that of the local oscillation light that is a target of polarized wave control. A specific example will be described below.

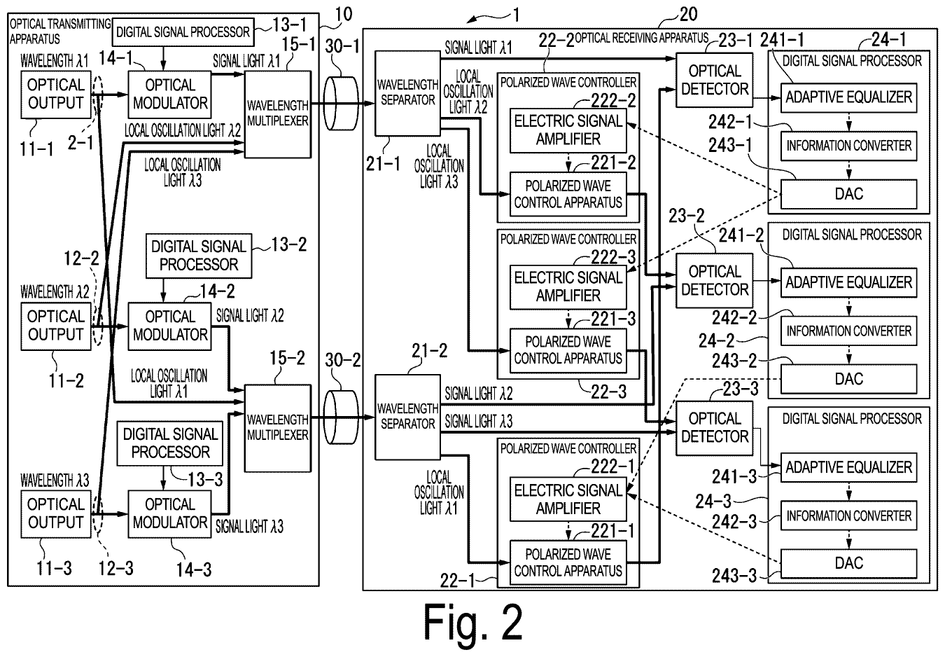

FIG. 2 is a block diagram illustrating a configuration example of the optical transmission system 1 in a case where N=3 and M=2 are defined. The operation of the optical transmission system 1 in the case where N=M=2 is defined is different from the operation of the optical transmission system 1 in a case where N=3 and M=2 are defined in the following.

The optical output 11-3 of the optical transmitting apparatus 10 generates light having a single wavelength λ3. The brancher 12-3 branches the light having the wavelength λ3 output from the optical output 11-3 into two pieces.

The brancher 12-3 outputs one piece of the branched light having the wavelength λ3 to the optical modulator 14-3, and outputs the other piece of the light to the wavelength multiplexer 15-1 as local oscillation light. The optical modulator 14-3 modulates the light having the wavelength λ3 using an electric signal generated by the digital signal processor 13-3 to generate polarized wave division multiplexed signal light, and outputs the generated signal light to the wavelength multiplexer 15-2. The wavelength multiplexer 15-1 multiplexes signal light having the wavelength λ1 input from the optical modulator 14-1, local oscillation light having the wavelength λ2 input from the optical output 11-2, and the local oscillation light having the wavelength λ3 input from the optical output 11-3, and outputs the multiplexed light to the optical transmission line 30-1. The wavelength multiplexer 15-2 multiplexes local oscillation light having the wavelength λ1 input from the optical output 11-1, signal light having the wavelength λ2 input from the optical modulator 14-2, and the signal light having the wavelength λ3 input from the optical modulator 14-3, and outputs the multiplexed light to the optical transmission line 30-2.

The wavelength separator 21-1 of the optical receiving apparatus 20 separates light input from the optical transmission line 30-1 by the wavelength. The wavelength separator 21-1 outputs the signal light having the wavelength λ1 to the optical detector 23-1, outputs the local oscillation light having the wavelength λ2 to the polarized wave controller 22-2, and outputs the local oscillation light having the wavelength λ3 to the polarized wave controller 22-3. The wavelength separator 21-2 separates light input from the optical transmission line 30-2 by the wavelength. The wavelength separator 21-2 outputs the signal light having the wavelength λ2 to the optical detector 23-2, outputs the signal light having the wavelength λ3 to the optical detector 23-3, and outputs the local oscillation light having the wavelength λ1 to the polarized wave controller 22-1.

The polarized wave control apparatus 221-3 of the polarized wave controller 22-3 performs polarized wave control related to polarized wave rotation and polarized wave mode dispersion on the local oscillation light having the wavelength λ3 input from the wavelength separator 21-1 using local oscillation light polarized wave control information input from the electric signal amplifier 222-3. The polarized wave control apparatus 221-3 outputs the local oscillation light having the wavelength λ3 subjected to polarized wave control to the optical detector 23-3. The optical detector 23-3 performs coherent detection on the signal light having the wavelength λ3 input from the wavelength separator 21-2 using the local oscillation light having the wavelength λ3 input from the polarized wave control apparatus 221-3, and generates an electric signal. The optical detector 23-3 outputs the generated electric signal to the digital signal processor 24-3.

The digital signal processor 24-3 outputs local oscillation light polarized wave control information generated using the electric signal input from the optical detector 23-3 to the polarized wave controller 22-1. The electric signal amplifier 222-1 of the polarized wave controller 22-1 amplifies at least one of local oscillation light polarized wave control information input from the digital signal processor 24-2 or the local oscillation light polarized wave control information input from the digital signal processor 24-3, and outputs the same to the polarized wave control apparatus 221-1.

On the other hand, the digital signal processor 24-1 outputs local oscillation light polarized wave control information generated using an electric signal input from the optical detector 23-1 to the polarized wave controller 22-2 and the polarized wave controller 22-3. The electric signal amplifier 222-3 of the polarized wave controller 22-3 amplifies the local oscillation light polarized wave control information input from the digital signal processor 24-1 and outputs the same to the polarized wave control apparatus 221-3.

In a case where N=M=3 is defined, the operation of the optical transmission system 1 is different from that in a case where N=3 and M=2 are defined as illustrated in FIG. 2, for example, as follows. The wavelength multiplexer 15-1 of the optical transmitting apparatus 10 multiplexes the signal light having the wavelength λ1 and the local oscillation light having the wavelength λ3 and outputs the multiplexed light to the optical transmission line 30-1, the wavelength multiplexer 15-2 multiplexes the signal light having the wavelength λ2 and the local oscillation light having the wavelength λ1 and outputs the multiplexed light to the optical transmission line 30-2, and the wavelength multiplexer 15-3 (not illustrated) multiplexes the signal light having the wavelength λ3 and the local oscillation light having the wavelength λ2 and outputs the multiplexed light to the optical transmission line 30-3 (not illustrated). The wavelength separator 21-1 of the optical receiving apparatus 20 separates the light input from the optical transmission line 30-1, outputs the signal light having the wavelength λ1 to the optical detector 23-1, and outputs the local oscillation light having the wavelength λ3 to the polarized wave controller 22-3. The wavelength separator 21-2 separates the light input from the optical transmission line 30-2, outputs the signal light having the wavelength λ2 to the optical detector 23-2, and outputs the local oscillation light having the wavelength λ1 to the polarized wave controller 22-1. The wavelength separator 21-3 (not illustrated) separates the light input from the optical transmission line 30-3 (not illustrated), outputs the signal light having the wavelength λ3 to the optical detector 23-3, and outputs the local oscillation light having the wavelength λ2 to the polarized wave controller 22-2. The digital signal processor 24-1 outputs the local oscillation light polarized wave control information generated using the electric signal input from the optical detector 23-1 to the polarized wave controller 22-3. The digital signal processor 24-2 outputs the local oscillation light polarized wave control information generated using the electric signal input from the optical detector 23-2 to the polarized wave controller 22-1. The digital signal processor 24-3 outputs the local oscillation light polarized wave control information generated using the electric signal input from the optical detector 23-3 to the polarized wave controller 22-1.

As described above, the optical transmission system 1 of the first embodiment performs polarized wave control of local oscillation light by utilizing signal light polarized wave control information output from the adaptive equalizer 241 in optical communication in a self-homodyne method using wavelength division multiplexing and polarized wave division multiplexing. As a result, it is possible to reduce a photoelectric convertor and an ADC that are conventionally necessary for polarized wave control.

### Second Embodiment

An optical transmission system of a second embodiment uses an optical communication method of a self-homodyne method using wavelength division multiplexing.

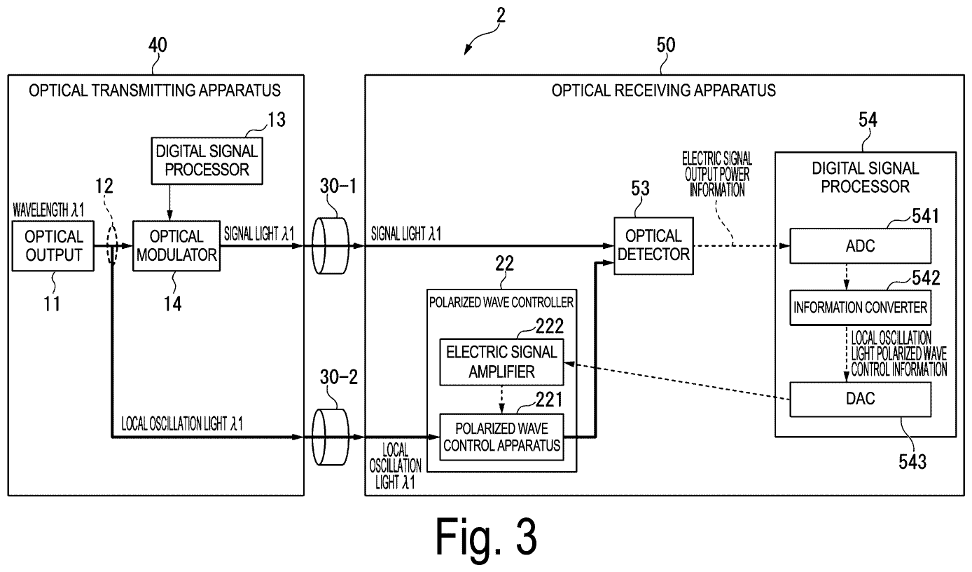

FIG. 3 is a block diagram illustrating a configuration of an optical transmission system 2 according to the second embodiment. The optical transmission system 2 includes an optical transmitting apparatus 40 and an optical receiving apparatus 50. As the optical transmitting apparatus 40, the conventional optical transmitting apparatus illustrated in FIG. 6 can be used. The optical transmitting apparatus 40 and the optical receiving apparatus 50 are connected by an optical transmission line 30-1 and an optical transmission line 30-2.

The optical transmitting apparatus 40 includes one optical output 11, one brancher 12, one digital signal processor 13, and one optical modulator 14. The optical output 11 generates light having a single wavelength λ1. The brancher 12 branches the light generated by the optical output 11 into two pieces, outputs one piece of the branched light to the optical modulator 14, and outputs the other piece of the light to the optical transmission line 30-2 as local oscillation light. The digital signal processor 13 outputs a generated electric signal to the optical modulator 14. The light having the wavelength λ1 output from the optical output 11 and branched by the brancher 12 is input to the optical modulator 14. The optical modulator 14 modulates the light having the wavelength λ1 using the electric signal input from the digital signal processor 13 to generate polarized wave division multiplexed signal light in which the power ratio between the x-polarized wave and the y-polarized wave is 1:1. The optical modulator 14 outputs the polarized wave division multiplexed signal light having the wavelength λ1 to the optical transmission line 30-1.

The optical receiving apparatus 50 includes a polarized wave controller 22, an optical detector 53, and a digital signal processor 54. The local oscillation light output from the optical transmission line 30-2 is input to the polarized wave controller 22. The polarized wave control apparatus 221 of the polarized wave controller 22 performs polarized wave control of the local oscillation light input from the optical transmission line 30-2 using local oscillation light polarized wave control information. The polarized wave control of the local oscillation light in the polarized wave control apparatus 221 may be, for example, control such that the power ratio between the x-polarized wave and the y-polarized wave is 1:1, or may be control performed such that a single polarized wave direction such that the x-polarized wave or the y-polarized wave is set and the power ratio between the x-polarized wave and the y-polarized wave of the local oscillation light is 1:1 in the optical detector 53. The polarized wave control apparatus 221 outputs the local oscillation light subjected to polarized wave control to the optical detector 53.

The optical detector 53 performs homodyne detection of signal light having the wavelength λ1 input from the optical transmission line 30-1 using the local oscillation light having the wavelength λ1 input from the polarized wave control apparatus 221, and converts the signal light into an electric signal. The optical detector 53 inputs electric signal output power information to the digital signal processor 54. The electric signal output power information is information indicating output power of an electric signal of the x-polarized wave and the y-polarized wave output after the homodyne detection. Since the signal light is a polarized wave multiplexed signal and output at the power ratio between the x-polarized wave and the y-polarized wave of the signal light of 1:1 on the transmission side, the power ratio between the x-polarized wave and the y-polarized wave of received signal light is also ideally 1:1. Therefore, the difference between the output power of the x-polarized wave and the output power of the y-polarized wave indicated by the electric signal output power information is equivalent to the difference between the output power of the x-polarized wave and the power of the y-polarized wave of the local oscillation light.

The digital signal processor 54 includes an ADC 541, an information converter 542, and a DAC 543. The ADC 541 converts the electric signal output power information input from the optical detector 53 from an analog signal to a digital signal, and outputs the converted electric signal output power information to the information converter 542.

The information converter 542 can be formed using, for example, an ASIC, an FPGA, or the like. The information converter 542 generates local oscillation light polarized wave control information for the electric signal output power information input from the ADC 541 using, for example, the steepest descent method. The information converter 542 outputs the generated local oscillation light polarized wave control information to the DAC 543.

The DAC 543 converts the local oscillation light polarized wave control information input from the information converter 542 from a digital signal to an analog signal, and outputs the converted local oscillation light polarized wave control information to the polarized wave controller 22. The electric signal amplifier 222 of the polarized wave controller 22 amplifies the local oscillation light polarized wave control information input from the DAC 543 and outputs the same to the polarized wave control apparatus 221.

Note that the optical transmitting apparatus may generate light having two or more wavelengths. In that case, the optical transmitting apparatus further includes the wavelength multiplexers 15 of the first embodiment. Each of the wavelength multiplexers 15 performs wavelength division multiplexing on signal light and local oscillation light having different wavelengths, and outputs the signal light and the local oscillation light to the optical transmission lines 30. The optical transmitting apparatus further includes the wavelength separators 21 of the first embodiment. Furthermore, the optical receiving apparatus includes the polarized wave controllers 22, the optical detectors 53, and the digital signal processors 54 for the number of wavelengths. Each of the wavelength separators 21 separates signal light and local oscillation light. The local oscillation light output from the optical transmission line 30 is subjected to polarized wave control by the polarized wave controller 22 according to the wavelength. The signal light and the local oscillation light are coherently detected by the optical detector 53 for each wavelength. Each of the optical detectors 53 outputs electric signal output power information obtained as a result of the coherent detection to the digital signal processor 54. The digital signal processor 54 generates local oscillation light polarized wave control information for each wavelength. Each of the polarized wave controller 22 performs polarized wave control using electric signal output power generated on the basis of signal light having the same wavelength as control target local oscillation light and the local oscillation light. A specific example will be described below.

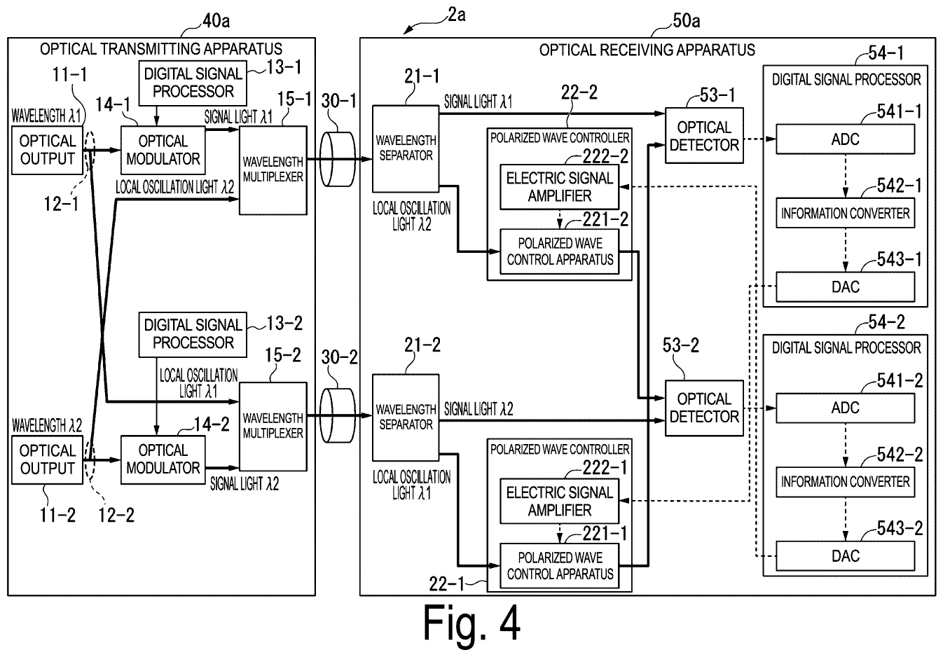

FIG. 4 is a block diagram illustrating a configuration example of an optical transmission system 2a that generates light having N (N is an integer of 2 or more) wavelengths. FIG. 4 illustrates a case where N=2 is defined as an example. The optical transmission system 2a includes an optical transmitting apparatus 40a and an optical receiving apparatus 50a. The optical transmitting apparatus 40a and the optical receiving apparatus 50a are connected by the optical transmission line 30-1 and the optical transmission line 30-2.

The optical transmitting apparatus 40a illustrated in FIG. 4 has a configuration similar to that of the optical transmitting apparatus 10 in a case where N=M=2 is defined as illustrated in FIG. 1. The optical receiving apparatus 50a has a configuration in which the optical detectors 23 and the digital signal processors 24 in the optical receiving apparatus 20 in a case where N=M=2 is defined as illustrated in FIG. 1 are replaced with the optical detectors 53 and the digital signal processors 54, respectively. The N optical detectors 53 are referred to as optical detectors 53-1 to 53-N and the N digital signal processors 54 are referred to as digital signal processors 54-1 to 54-N. The ADC 541, the information converter 542, and the DAC 543 included in the digital signal processor 54-i (i is an integer of 1 or more and N or less) are referred to as the ADC 541-i, the information converter 542-i, and the DAC 543-i, respectively.

The optical transmitting apparatus 40a operates similarly to the optical transmitting apparatus 10 of the first embodiment illustrated in FIG. 1. The wavelength Separator 21-1 of the optical receiving apparatus 50a separates light input from the optical transmission line 30-1 by the wavelength. The wavelength separator 21-1 outputs the signal light having the wavelength λ1 to the optical detector 53-1, and outputs the local oscillation light having the wavelength λ2 to the polarized wave control apparatus 221-2. The polarized wave control apparatus 221-2 performs polarized wave control on the local oscillation light having the wavelength 22 using local oscillation light polarized wave control information input from the electric signal amplifier 222-2. The polarized wave control apparatus 221-2 outputs the local oscillation light having the wavelength λ2 subjected to polarized wave control to the optical detector 53-2.

The wavelength separator 21-2 separates light input from the optical transmission line 30-2 by the wavelength. The wavelength separator 21-2 outputs the signal light having the wavelength λ2 to the optical detector 53-2, and outputs the local oscillation light having the wavelength λ1 to the polarized wave control apparatus 221-1. The polarized wave control apparatus 221-1 performs polarized wave control on the local oscillation light having the wavelength λ1 using local oscillation light polarized wave control information input from the electric signal amplifier 222-1. The polarized wave control apparatus 221-1 outputs the local oscillation light having the wavelength λ1 subjected to polarized wave control to the optical detector 53-1.

The optical detector 53-1 performs coherent detection on the signal light having the wavelength λ1 input from the wavelength separator 21-1 using the local oscillation light having λ1 input from the polarized wave control apparatus 221-1, and generates an electric signal. The optical detector 53-1 outputs electric signal output power information to the digital signal processor 54-1. The digital signal processor 54-1 outputs the local oscillation light polarized wave control information generated using electric signal output power information input from the optical detector 53-1 to the electric signal amplifier 222-1 of the polarized wave controller 22-1.

The optical detector 53-2 performs coherent detection on the signal light having the wavelength λ2 input from the wavelength separator 21-2 using the local oscillation light having λ2 input from the polarized wave control apparatus 221-2, and generates an electric signal. The optical detector 53-2 outputs electric signal output power information to the digital signal processor 54-2. The digital signal processor 54-2 outputs local oscillation light polarized wave control information generated using the electric signal output power information input from the optical detector 53-2 to the electric signal amplifier 222-2 of the polarized wave controller 22-2.

As described above, the optical transmission systems 2 and 2a of the second embodiment perform polarized wave control of local oscillation light using electric signal output power information of the x-polarized wave and the y-polarized wave output after self-homodyne detection of signal light and local oscillation light in optical communication of the self-homodyne method using polarized wave division multiplexing. As a result, it is possible to eliminate a photoelectric convertor that is conventionally necessary for polarized wave control of local oscillation light.

### Third Embodiment

An optical transmission system of a third embodiment uses an optical communication method of a self-homodyne method using wavelength division multiplexing and polarized wave division multiplexing. In the optical transmission System of the third embodiment, an optical receiving apparatus has a configuration including the function of the digital signal processor of the first embodiment and the function of the digital signal processor of the second embodiment.

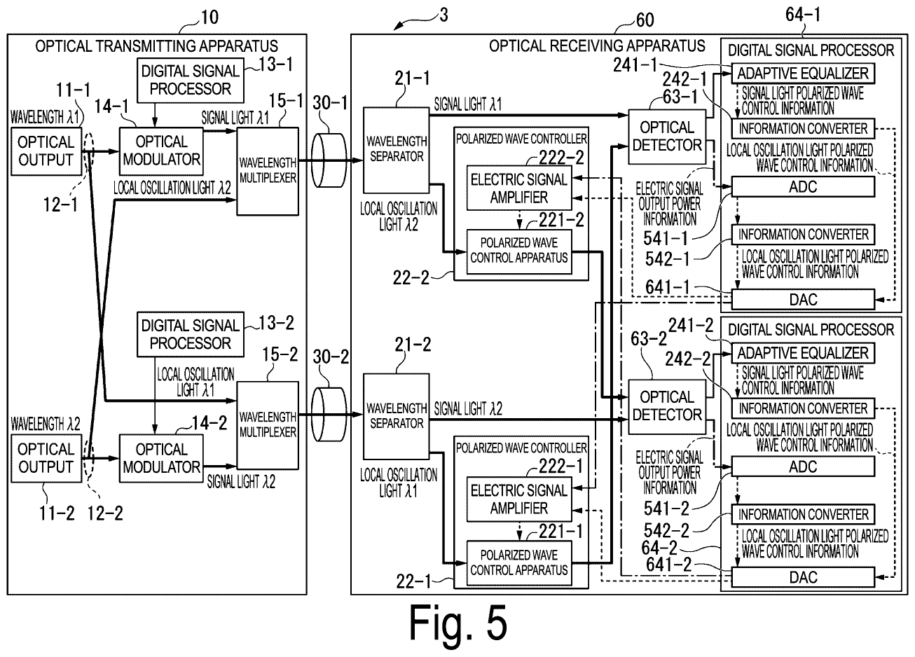

FIG. 5 is a block diagram illustrating a configuration of an optical transmission system 3 according to the third embodiment. Thin broken line arrows and thin one dot chain line arrows indicate paths of electric control signals. The optical transmission system 3 illustrated in FIG. 5 is different from the optical transmission system 1 of the first embodiment illustrated in FIG. 1 in that an optical receiving apparatus 60 is included instead of the optical receiving apparatus 20.

The optical receiving apparatus 60 is different from the optical receiving apparatus 20 of the first embodiment illustrated in FIG. 1 in that N (N is an integer of 2 or more) optical detectors 63 are included instead of the N optical detectors 23, and N digital signal processors 64 are included instead of the N digital signal processors 24. The N optical detectors 63 are referred to as optical detectors 63-1 to 63-N and the N digital signal processors 64 are referred to as digital signal processors 64-1 to 64-N.

The optical detector 63-i (i is an integer of 1 or more and N or less) performs coherent detection of signal light having a wavelength λi using local oscillation light having the wavelength λi output from a polarized wave control apparatus 221-i of a polarized wave controller 22-i, and converts the signal light into an electric signal. The optical detector 63-i outputs the generated electric signal and electric signal output power information that is information of the output power of the x-polarized wave and the y-polarized wave of the generated electric signal to the digital signal processor 64-i.

Each of the digital signal processors 64 includes an adaptive equalizer 241, an information converter 242, an ADC 541, an information converter 542, and a DAC 641. The adaptive equalizer 241, the information converter 242, the ADC 541, the information converter 542, and the DAC 641 included in the digital signal processor 64-i are referred to as the adaptive equalizer 241-i, the information converter 242-i, the ADC 541-i, the information converter 542-i, and the DAC 243-i, respectively.

The adaptive equalizer 241-i and the information converter 242-i of the digital signal processor 64-i perform processing similar to that of the first embodiment. The information converter 242-i outputs generated local oscillation light polarized wave control information to the DAC 641-i. The DAC 641-i converts the local oscillation light polarized wave control information input from the information converter 242-i from a digital signal to an analog signal. The DAC 641-i outputs the local oscillation light polarized wave control information converted into the analog signal to the electric signal amplifier 222-j (j is an integer of 1 or more and N or less, and i≠j is defined) of the polarized wave controller 22-jcorresponding to the local oscillation light having a wavelength λj multiplexed with the signal light having the wavelength λi and transmitted.

The ADC 541-i and the information converter 542-i of the digital signal processor 64-i perform processing similar to that of the second embodiment. The information converter 542-i outputs generated local oscillation light polarized wave control information to the DAC 641-i. The DAC 641-i converts the local oscillation light polarized wave control information input from the information converter 542-i from a digital signal to an analog signal. The DAC 641-i outputs the local oscillation light polarized wave control information converted into the analog signal to the electric signal amplifier 222-i of the polarized wave controller 22-i.

The electric signal amplifier 222-i of the polarized wave controller 22-i amplifies any one piece of the local oscillation light polarized wave control information input from the digital signal processor 64-i or any one piece of local oscillation light polarized wave control information input from the digital signal processor 64-j, and outputs the same to the polarized wave control apparatus 221-i.

As described above, the polarized wave controller 22 may control the polarized wave of local oscillation light having different wavelengths transmitted by performing wavelength division multiplexing in the optical transmission line 30 same as that of signal light using local oscillation light polarized wave control information obtained by converting signal light polarized wave control information output by the adaptive equalizer 241 by the information converter 242. Alternatively, the polarized wave controller 22 may control the polarized wave of local oscillation light that is input from the optical transmission line 30 different from that of signal light and has the same wavelength as the signal light using local oscillation light polarized wave control information obtained by converting the electric signal output power information output by the optical detector 63 by the information converter 542.

As described above, in the optical communication in the self-homodyne method using wavelength division multiplexing and polarized wave division multiplexing, the optical transmission system 3 of the third embodiment converts signal light polarized wave control information of the adaptive equalizer 241 into local oscillation light polarized wave control information and performs polarized wave control of local oscillation light, or converts electric signal output power information of the x-polarized wave and the y-polarized wave output after self-homodyne detection of signal light and local oscillation light into local oscillation light polarized wave control information and performs polarized wave control of local oscillation light. As a result, it is possible to eliminate a photoelectric convertor that is conventionally necessary for polarized wave control of local oscillation light.

At least some of the functions of the digital signal processors 24, 54, and 64 included in the optical receiving apparatus of the above-described embodiments may be implemented by a computer. In that case, a program for implementing the functions of the digital signal processors 24, 54, and 64 may be recorded in a computer-readable recording medium, and the program recorded in the recording medium may be read and executed by a computer system to implement the functions. Assume that the computer system includes, for example, a processor, an OS, and hardware such as peripheral apparatuses. The program of the signal processing apparatus may be recorded on a computer-readable recording medium. The computer-readable recording medium is, for example, a portable medium such as a flexible disk, a magneto-optical disc, a ROM, or a CD-ROM or a storage apparatus such as a hard disk built in a computer system. The program of the signal processing apparatus may be transmitted via a telecommunication line.

According to the embodiments described above, the number of functional blocks for performing polarized wave control of local oscillation light transmitted from an optical transmitting apparatus can be reduced, and an optical receiving apparatus can perform efficient polarized wave control.

According to the above-described embodiments, an optical transmission system includes an optical transmitting apparatus and an optical receiving apparatus. The optical transmitting apparatus includes an optical output, a brancher, and an optical modulator. The optical output outputs light having a single wavelength. The brancher branches the light output from the optical output into light for signal generation and local oscillation light. The optical modulator modulates light for the signal generation into polarized wave-multiplexed signal light. The optical receiving apparatus includes an optical detector, a signal processor, and a polarized wave controller. The optical detector coherently detects the signal light transmitted through an optical transmission line by the local oscillation light transmitted through an optical transmission line different from the optical transmission line through which the signal light is transmitted. The signal processor generates local oscillation light polarized wave control information for compensating for a fluctuation that has occurred in a polarized wave of local oscillation light during transmission on a basis of a signal obtained by coherent detection. The polarized wave controller performs polarized wave control of local oscillation light used by the optical detector for coherent detection on a basis of the local oscillation light polarized wave control information.

The optical output may output light having different wavelengths generated by a plurality of respective lasers. The brancher branches the light having a plurality of wavelengths output from the optical output into light for signal generation and local oscillation light. The optical modulator modulates light for the signal generation having each of a plurality of wavelengths into polarized wave-multiplexed signal light. The optical transmitting apparatus further includes a wavelength multiplexer. The wavelength multiplexer generates light obtained by combining at least one piece of signal light and at least one piece of local oscillation light having a wavelength different from a wavelength of the signal light, and transmits a plurality of pieces of the generated light to the optical receiving apparatus via respective different optical transmission lines. The optical receiving apparatus further includes a wavelength separator. The wavelength separator separates the light transmitted through each of the different optical transmission lines into the signal light and the local oscillation light by a wavelength. The optical detector coherently detects the signal light by the local oscillation light having the same wavelength as that of the signal light. The signal processor performs one or both of types of processing of compensating for polarized wave rotation and polarized wave mode dispersion of the signal obtained by coherent detection and generating local oscillation light polarized wave control information of the local oscillation light multiplexed with the signal light used for the coherent detection and transmitted on a basis of compensation performed on the signal and processing of generating local oscillation light polarized wave control information of the local oscillation light having a same wavelength as the signal light used for the coherent detection on a basis of information of electric signal output power of two different polarized waves obtained by coherent detection.

The signal processor may generate the local oscillation light polarized wave control information for compensating for polarized wave rotation and polarized wave mode dispersion of the signal light on a basis of information of electric signal output power of two different polarized waves obtained by coherent detection.

The signal processor may generate Jones matrix information obtained by performing Fourier transform on tap coefficient information generated in a case where polarized wave rotation and polarized wave mode dispersion are compensated for to the signal obtained by coherent detection as local oscillation light polarized wave control information. Alternatively, the signal processor may generate the local oscillation light polarized wave control information for information of electric signal output power of two different polarized waves obtained by coherent detection using a steepest descent method.

Although the embodiments of the present invention have been described in detail with reference to the drawings so far, specific configurations are not limited to these embodiments, and include designs, and the like, without departing from the gist of the invention.

### REFERENCE SIGNS LIST

1, 2, 2a, 3 Optical transmission system
10 Optical transmitting apparatus
11, 11-1 to 11-3 Optical output
12, 12-1 to 12-3 Brancher
13, 13-1 to 13-3 Digital signal processor
14, 14-1 to 14-3 Optical modulator
15, 15-1, 15-2 Wavelength multiplexer
20 Optical receiving apparatus
21-1, 21-2 Wavelength separator
22, 22-1 to 22-3 Polarized wave controller
23-1 to 23-3 Optical detector
24-1 to 24-3 Digital signal processor
30-1, 30-2 Optical transmission line
40, 40a Optical transmitting apparatus
50, 50a Optical receiving apparatus
53, 53-1, 53-2 Optical detector
54, 54-1, 54-2 Digital signal processor
60 Optical receiving apparatus
63-1, 63-2 Optical detector
64-1, 64-2 Digital signal processor
221, 221-1 to 221-3 Polarized wave control apparatus
222, 222-1 to 222-3 Electric signal amplifier
241-1 to 241-3 Adaptive equalizer
242-1 to 242-3 Information converter
243-1 to 243-3 DAC
541, 541-1, 541-2 ADC
542, 542-1, 542-2 Information converter
543, 543-1, 543-2 DAC
641-1, 641-2 DAC

1. An optical transmission system comprising an optical transmitting apparatus and an optical receiving apparatus,
wherein the optical transmitting apparatus comprises:
a first processor; and
a first storage medium having first computer program instructions stored thereon, when executed by the first processor, perform to:
output light having a single wavelength;
branch the light output into light for signal generation and local oscillation light; and
modulate light for the signal generation into polarized wave-multiplexed signal light, and
the optical receiving apparatus comprises:
a second processor; and
a second storage medium having second computer program instructions stored thereon, when executed by the second processor, perform to:
coherently detect the signal light transmitted through an optical transmission line by the local oscillation light transmitted through an optical transmission line different from the optical transmission line through which the signal light is transmitted;
generate local oscillation light polarized wave control information for compensating for a fluctuation that has occurred in a polarized wave of local oscillation light during transmission on a basis of a signal obtained by coherent detection; and
perform polarized wave control of the local oscillation light used for coherent detection on a basis of the local oscillation light polarized wave control information.

2. The optical transmission system according to claim 1, wherein the first computer program instructions further perform to:
output light having different wavelengths generated by a plurality of respective lasers,
branch the light of each of a plurality of wavelengths output into light for signal generation and local oscillation light,
modulate light for the signal generation having each of a plurality of wavelengths into polarized wave-multiplexed signal light,
generate light obtained by multiplexing at least one piece of the signal light and at least one piece of the local oscillation light having a wavelength different from a wavelength of the signal light, and output a plurality of pieces of the generated light to respective different optical transmission lines, and
wherein the second computer program instructions further perform to:
separate the light transmitted through each of the different optical transmission lines into the signal light and the local oscillation light by a wavelength,
coherently detect the signal light by the local oscillation light having a same wavelength as the signal light, and
compensate for polarized wave rotation and polarized wave mode dispersion of the signal obtained by coherent detection, and generate local oscillation light polarized wave control information of the local oscillation light multiplexed with the signal light used for the coherent detection and transmitted on a basis of compensation performed on the signal.

3. The optical transmission system according to claim 2,
wherein the second computer program instructions further perform to:
instead of or in addition to processing of compensating for polarized wave rotation and polarized wave mode dispersion of the signal obtained by coherent detection and generating local oscillation light polarized wave control information of the local oscillation light multiplexed with the signal light used for the coherent detection and transmitted on a basis of compensation performed on the signal, processing of generating local oscillation light polarized wave control information of the local oscillation light having a same wavelength as the signal light used for the coherent detection on a basis of information of electric signal output power of two different polarized waves obtained by coherent detection.

4. The optical transmission system according to claim 2,
wherein the signal processor generates the second computer program instructions further perform to:
generate Jones matrix information obtained by performing Fourier transform on tap coefficient information generated in a case where polarized wave rotation and polarized wave mode dispersion are compensated for to the signal obtained by coherent detection as local oscillation light polarized wave control information.

5. The optical transmission system according to claim 1,
wherein the second computer program instructions further perform to:
generate the local oscillation light polarized wave control information on a basis of information of electric signal output power of two different polarized waves obtained by coherent detection.

6. The optical transmission system according to claim 5,
wherein the signal processor generates-the second computer program instructions further perform to:
generate the local oscillation light polarized wave control information for information of electric signal output power of two different polarized waves obtained by coherent detection using a steepest descent method.

7. An optical receiving apparatus comprising:
a processor; and
a storage medium having first computer program instructions stored thereon, when executed by the processor, perform to:
branch light having a single wavelength into light for signal generation and local oscillation light, receive as input, from an optical transmitting apparatus that modulates light for the signal generation to generate polarized wave-multiplexed signal light, the signal light and the local oscillation light transmitted via different optical transmission lines, and coherently detect the signal light by the local oscillation light;
generates generate local oscillation light polarized wave control information for compensating for a fluctuation that has occurred in a polarized wave of local oscillation light during transmission on a basis of a signal obtained by coherent detection; and
perform polarized wave control of the local oscillation light used by the optical detector for coherent detection on a basis of the local oscillation light polarized wave control information.

8. An optical transmission method in an optical transmission system including an optical transmitting apparatus and an optical receiving apparatus, the optical transmission method comprising:
outputting, by the optical transmitting apparatus, light having a single wavelength;
branching, by the optical transmitting apparatus, the light output into light for signal generation and local oscillation light;
modulating, by the optical transmitting apparatus, light for the signal generation into polarized wave-multiplexed signal light;
coherently detecting, by the optical receiving apparatus, the signal light transmitted through an optical transmission line by the local oscillation light transmitted through an optical transmission line different from the optical transmission line through which the signal light is transmitted;
generating, by the optical receiving apparatus, local oscillation light polarized wave control information for compensating for a fluctuation that has occurred in a polarized wave of local oscillation light during transmission on a basis of a signal obtained by coherent detection; and
performing, by the optical receiving apparatus, polarized wave control of the local oscillation light used for the coherent detection on a basis of the local oscillation light polarized wave control information.
